(19) United States
(12) Patent Application Publication
(10) Pub. No.: US 2015/0217492 A1
(43) Pub. Date: Aug. 6, 2015

(54) Method for producing a radiator box or charge air cooler box

(71) Applicant: Halla Visteon Climate Control Corp., Daejeon (KR)

(72) Inventors: Thomas Alberternst, Aachen (DE); Petr Daniel, Valasske Mezirici (CZ); Adam Salinger, Bilovice (CZ)

(21) Appl. No.: 14/609,844

(22) Filed: Jan. 30, 2015

(30) Foreign Application Priority Data
Jan. 30, 2014 (DE) 102014101143.0

(51) Int. Cl. B29C 45/00; B65D 85/68

(52) U.S. Cl. CPC B29C 45/0003; B65D 85/68; B65D 2585/6812; B29K 2023/10

(57) ABSTRACT

The invention relates to a method for producing a radiator box or charge air cooler box in the form of a plastic box with an integrated seal by means of two-component injection molding using an injection molding tool. The injection molding tool includes a first main part, a second main part and a movable sliding element core as the third main part, the parts forming a first cavity for at least one part of the plastic box and, by a relative movement of the movable sliding element core, a second cavity, immediately adjacent to the first cavity, for a seal material.

### CROSS-REFERENCES TO RELATED APPLICATIONS

This application claims priority to German Patent Application No. 10 2014 101143.0, filed on Jan. 30, 2014, the disclosure of which is incorporated herein by reference in its entirety.

### FIELD OF THE DISCLOSURE

The invention relates to a method for producing a radiator box or charge air cooler box in the form of a plastic box with an integrated seal. The invention further relates to a radiator box or charge air cooler box in the form of a plastic box with an integrated seal which is obtainable by the method according to the invention.

### BACKGROUND

Radiator tanks or charge air cooler tanks are manufactured by injection molding technical thermoplastics, for example using a glass fiber-filled polyamide, for example PA66-GF30. The seal is produced separately, likewise by injection molding, for example using a terpolymer elastomer (rubber) of synthetic ethylene propylene diene rubber, abbreviated EPDM. The components are then assembled together with the heat exchanger, which is made of aluminum, for example. WO 2008/030015 A1 and KR 2008 0 021 32 8 A describe process chains for integrating the seal, in which the radiator tank or charge air cooler tank, produced in advance, is placed in an additional tool to form a cavity therein for the seal. A primer is injected into this die cavity, followed by liquid silicone rubber, abbreviated LSR. EP 2 093 040 A1 describes an injection molding process comprising two process steps, in which a plurality of sliding elements are pulled in the main opening direction and in the lateral direction in order to open up the second cavity.

The process currently used most frequently for producing tank and seal requires that the components be produced separately. The assembly of the components further involves a certain amount of control expenditure. The processes described in the aforementioned documents result in an assembly module. Sufficient adhesion of the elastomer is achieved in these processes by using a primer as an adhesion promoter. With the injection molding variant presented, a plurality of sliding elements is required. Smooth joining faces are involved. A secure adhesion of the seal material is achieved through a lateral form-fitting connection.

### SUMMARY

The object of the present invention consists in providing the simplest possible process for producing a radiator box or charge air cooler box having a seal.

The object of the invention is attained with a method for producing a radiator box or charge air cooler box according to claim 1. According to the invention, a radiator box or charge air cooler box is produced in the form of a plastic box having an integrated seal by means of two-component injection molding, using an injection molding tool which comprises a first main part, a second main part and a movable sliding element core as a third main part, which parts form a first cavity for at least one part of the plastic box and, by executing a relative movement of the movable sliding element core, a second cavity, immediately adjacent to the first cavity, for a seal material.

In the method:
a) the plastic box is produced by injection molding plastic into the first cavity, and the movable sliding element core is initially positioned such that it abuts the first cavity and fills in the second cavity such that no plastic can enter the second cavity,
b) once a holding pressure phase has ended and the plastic box has cooled sufficiently, the sliding element core is displaced in the injection molding tool in the main tool opening direction—away from the abutting first cavity—such that the second cavity is opened up, and
c) a seal material is injected into the second cavity.

Within the context of the present invention, the main tool opening direction is understood as the opening movement that opens up the cavity for the plastic box, perpendicular to the contact face between the first and second main parts.

The advantages of the present invention consist in the integration of the seal into the plastic box, which results in a defined fixation and facilitated assembly. The plastic box for the radiator or charge air cooler is produced with a seal in a single production process. The separate production of the seal and the increased assembly and control expense for three components are thereby eliminated. This results in a minimization of handling of components and tool parts. With respect to the seal contour, the tool design provides a sliding element core which has a short stroke in the main tool opening direction. Particularly advantageous is an embodiment of the invention in which the outer contour of the seal that will later be integrated is determined by the shape of the sliding element core end face that points in the direction of the first cavity.

A particular advantage of the invention is that it enables the form of the functional surface of the tank base of the plastic box and the seal to be determined. For instance, the contour of this tank base, that is the lower part of a wall of the plastic box to be produced, and of the seal can first be embodied as inverted. The resulting seal contour is advantageously embedded into a groove, that is, a certain part of the seal is integrated into the tank and/or the plastic box. This results in a forth-fitting connection, in addition to a certain adhesive connection, and thereby a certain retaining force of the seal on the plastic box, which is of sufficient strength to withstand the subsequent handling of the components and the tool.

The seal material for producing the seal can advantageously be fed in via at least one connection in the main tool opening direction or also laterally via at least one connection in the region of the dividing line between the fixed and movable main parts, that is, between the first and second main parts of the injection molding tool.

The radiator box or charge air cooler box is preferably produced by injection molding using thermoplastics, preferably technical thermoplastics. According to a particularly preferred embodiment, a glass fiber-filled polyimide, for example PA66-GF30, is used as the technical thermoplastic for producing the radiator box or charge air cooler box. A material having a polypropylene base, for example PP-GF30, can also be used as the thermoplastic for producing the radiator box or charge air cooler box.

The end face seal contour can be designed as semicircular in shape, as has heretofore been standard; this allows the end face seal to achieve a certain tolerance compensation for the material of the heat transfer element that will subsequently be installed, and which in most cases is made of aluminum. According to an advantageous embodiment of the invention, curing molding compounds are used as the seal material. A curing seal material is preferably fed in while heat is simultaneously applied. When curing molding compounds, for example ethylene propylene diene rubber (EPDM), liquid silicone rubber (LSR) or fluorocarbon rubber (FKM), are used as the seal material, the still very high surface temperature of the solidified but not yet fully cooled plastic box can be used for curing. The demolding temperature of PA66-GF30 is approximately 220° C., for example.

The tool concept according to the invention can also be used for processing polyurethane (PUR) in a closed tool. Thus a one-component or two-component polyurethane molding compound (PUR) can likewise be used as the seal material.

A thermoplastic elastomer (TPE) can also be processed likewise as the seal material in the form described here. In this case, the seal material is fed in while heat is simultaneously removed.

According to an advantageous embodiment of the invention, the second main part of the injection molding tool and the sliding element core are made of tool materials having different thermometric conductivities, with the sliding element core having a higher thermometric conductivity than the second main part of the injection molding tool. Using tool materials that have different thermometric conductivities allows the different requirements of thermoplastic or elastomeric processing to be taken into consideration.

A further aspect of the invention relates to a radiator box or charge air cooler box in the form of a plastic box having an integrated seal, which is obtainable in one of the above-described embodiments by a method according to the invention.

### BRIEF DESCRIPTION OF THE DRAWINGS

Further details, features and advantages of the invention are found in the following description of embodiment examples with reference to the attached set of drawings. The drawings show:

FIG. 1: an example of a radiator box or charge air cooler box of the prior art,

FIGS. 2A-2C: a schematic representation of the sequence of steps in a two-component injection molding process involving integration of a seal, and

FIGS. 3A-3C: a schematic representation of the sequence of steps in a two-component injection molding process involving integration of a seal using heating elements.

### DETAILED DESCRIPTION OF THE INVENTION

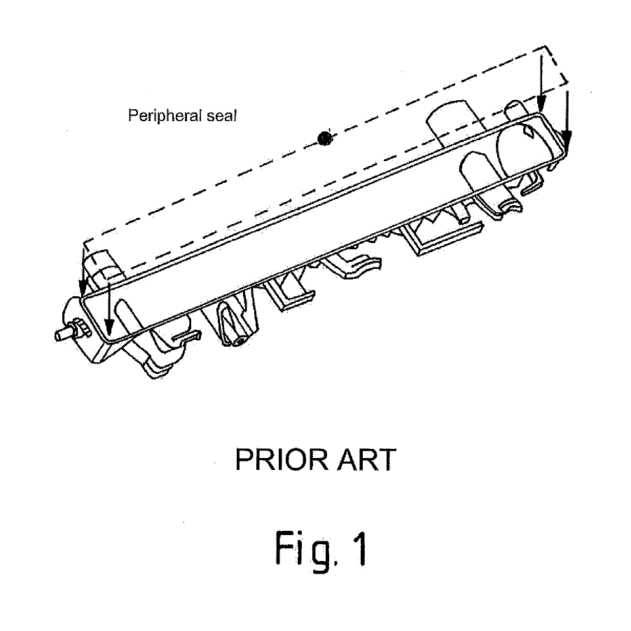

FIG. 1 shows an example of a radiator box or charge air cooler box made of plastic and having a peripheral seal, according to the prior art. This plastic box is highly complex, that is, designed with a multiplicity of integrated functions. Corresponding injection molding tools are required for producing the plastic box. In most cases the seal is produced separately with a constant cross-sectional shape.

Various tool concepts exist for the two-component method. The so-called serial process involves injecting a hard component for the plastic box, and subsequently processing said plastic box. The fully cooled material is then introduced into an elastomer tool, and a soft component, an elastomer, is molded over said material. In each case, this process is suitable for only a similar box design, and producing the seal is highly costly.

The so-called integrated process is distinguished from the above serial process. According to one variant of this integrated process, the hard component can first be injected into a first cavity, then transferred to a second cavity, for example by means of rotation, and in a second step, the seal material is processed in the second cavity. The tool that is required for this must be very large as compared with other injection molding tools, and the process as a whole appears to be highly costly.

The invention applies a different form of the integrated process as the tool concept. In this case, the hard component is injected, after which a second cavity integrated into the tool is opened up and the soft component, for example an elastomer, is injected, with both injections, that of the thermoplastic and that of the elastomer, therefore being carried out within a single injection cycle in a single tool.

With this variant of the integrated process, although the tool complexity is greater than that of injection molding tools used for serial processing of thermoplastics, it is still manageable. This form of the integrated process requires a corresponding machine, and requires a slight increase in overall cycle time over that of the one-component process.

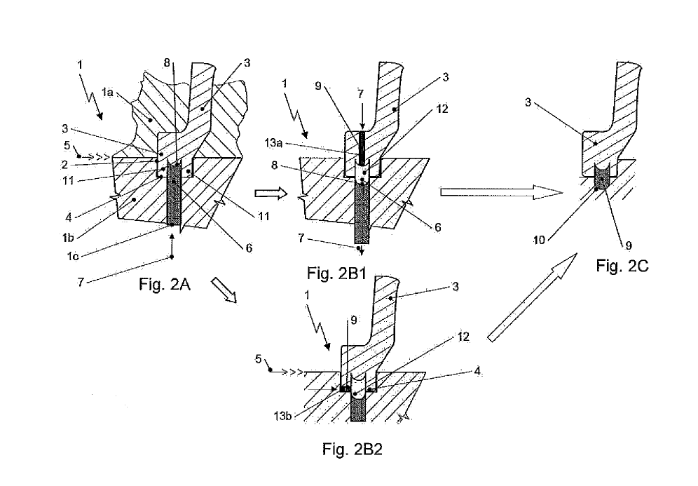

FIGS. 2A-2C show a schematic representation of the sequence of steps in an integrated two-component injection molding process. FIG. 2A shows an injection molding tool 1 with a fixed, first main part 1a, a movable, second main part 1b and a movable sliding element core 1c as a third main part of the injection molding tool 1. Depending on the geometry of the injection molded box to be produced, it can also be advantageous for the first main part 1a to be embodied as movable, and for the second main part 1b to represent the fixed side of the tool. The second main part 1b of injection molding tool 1 provides a groove-like receiving space 2 for the lower part of a wall of the radiator box or charge air cooler box and/or a plastic box 3 to be produced, also called the tank base. In most cases, a base surface 4 of the receiving space 2 lies below a dividing line 5 between the first main part 1a and the second main part 1b of the injection molding tool 1. A channel-like guide space 6 for the sliding element core 1c, which is vertically movable according to FIGS. 2A-2C, extends from the base surface 4. The dimensions of the sliding element core 1c perpendicular to a displacement direction or a main tool opening direction 7 of the sliding element core 1c correspond to the corresponding dimensions of the guide space 6. An end face 8 pointing in a direction of the receiving space 2, which the end face has a concave shape according to FIG. 2A, determines an outer contour 10 of a seal or a seal material 9 that will later be integrated. As represented in FIG. 2C, the outer contour 10 is embodied as correspondingly convex.

According to FIG. 2A, the movable sliding element core 1c is initially positioned such that it fills up at least a part of the guide space 6 that is immediately adjacent to the receiving space 2, and such that it projects into the receiving space 2, wherein a part of the receiving space 2 that is not filled up by the sliding element core 1c forms a first cavity 11, namely for the injection molding of the thermoplastic material of the plastic box 3. FIG. 2A shows the phase of the process in which the plastic box 3 made of thermoplastic material has been produced in the first cavity 11 by means of injection molding. Once a holding pressure phase has ended and the plastic box 3 has cooled sufficiently, the sliding element core 1c, as shown in both FIG. 2B1 and FIG. 2B2, is displaced out of the receiving space 2 into the guide space 6. As a result, a second cavity 12 is opened up, which according to the representation of FIG. 2B1 and FIG. 2B2, extends into the guide space 6. The displacement direction 7 corresponds to the main tool opening direction 7. The second cavity 12 is provided for receiving the so-called soft component, seal material 9. The seal material 9 can be fed in via a connection 13a in the main tool opening direction 7, as represented in FIG. 2B1. Alternatively, the seal material 9 is fed in laterally via a connection 13b in the region of the dividing line 5, in the illustrated embodiment example, below the dividing line 5, as represented in FIG. 2B2.

FIG. 2C shows the seal material 9 injected into the second cavity 12. The convex outer contour 10 of the resulting seal material 9 corresponds with the concave contour of the end face 8 at an upper end of the sliding element core 1c, as is clear from a comparison of FIGS. 2B1-2C.

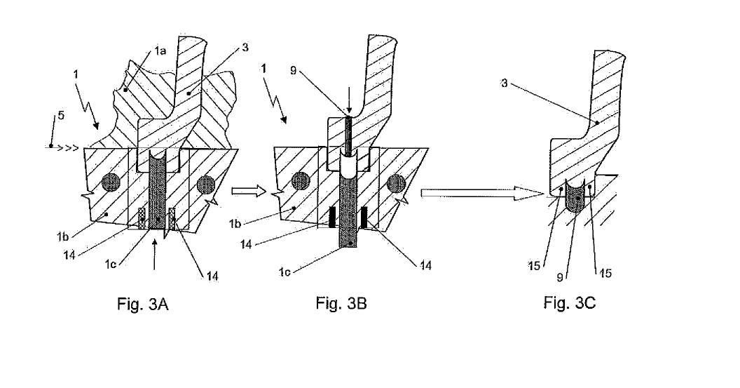

As is represented schematically in FIGS. 3A-3C, the curing seal material 9 is advantageously fed in while heat is simultaneously applied. For this purpose, heating elements 14 can be integrated into the injection molding tool 1, as shown in FIGS. 3A-3B, with the heating elements 14 being activated during the infeeding of the seal material 9 as shown in FIG. 3B. The heating elements 14 are positioned in the second main part 1b close to the walls of the guide space 6, that is, around the guide space 6. The second main part 1b is made of a material that has a lower thermometric conductivity than the material of the sliding element core 1c. The material of the sliding element core 1c advantageously has a high thermometric conductivity, in order to transmit heat to the seal material 9 which is fed into the second cavity 12. Embodying the injection molding tool 1 with materials having different thermometric conductivities enables a thermal separation of the regions for producing the plastic box 3 on one hand and the seal material 9 on the other. A rapid curing of the seal material 9 can thereby be achieved, if necessary. If curing molding compounds are used, good heat conduction via the sliding element core 1c can thus support the temperature-dependent curing process of the seal material 9, while at the same time, the supply of heat to the material of the already solidified thermoplastic box is kept low due to the poorer heat conducting properties of the material of the second main part 1b. In contrast, if non-curing molding compounds are used, an intensive cooling of this region can occur, in order to rapidly dissipate the heat in this area.

FIG. 3C shows a schematic illustration of a “base” of the plastic box 3 with the cured seal material 9. The resulting seal material 9, as shown in FIG. 3C, is embedded in a groove between two base arms 15 of the plastic box 3. In addition to a certain adhesive connection, a form-fitting connection is thereby produced, and as a result, a certain retaining force of the seal material 9 on the plastic box 3, which is sufficient to withstand subsequent handling.

### LIST OF REFERENCE SIGNS

1 injection molding tool
1a first main part, main part (fixed)
1b second main part (movable), main part
1c (movable) sliding element core, third main part, main part
2 receiving space
3 radiator box or charge air cooler box, plastic box
4 base surface
5 dividing line
6 guide space
7 displacement direction, main tool opening direction
8 end face
9 seal, seal material, seal contour
10 outer contour (of seal 9)
11 first cavity
12 second cavity
13a connection in main tool opening direction 7
13b connection below dividing line 4, connection in the region of the dividing line
14 heating elements
15 base arms

1-14. (canceled)

15. A method for producing a plastic box with an integrated seal for at least one of a radiator and a charge air cooler comprising the steps of:
providing an injection molding tool including a first main part, a second main part, and a movable sliding element core, the first main part, the second main part, and the movable sliding element core cooperating to form a first cavity and a second cavity adjacent the first cavity configured to receive a seal material;
moving the movable sliding element core within the second cavity to an initial position to abut the first cavity and seal the second cavity;
injecting a plastic into the first cavity by an injection molding process;
permitting a holding pressure phase of the injection molding process to end and the plastic to substantially cool;
moving the movable sliding element core in a main tool opening direction away from the initial position to open the second cavity; and
injecting a seal material into the second cavity to form the integrated seal of the plastic box.

16. The method according to claim 15, wherein the movable sliding element core includes an end face having a shape corresponding to a shape of an outer contour of the integrated seal.

17. The method according to claim 15, wherein the step of injecting the seal material into the second cavity includes the step of feeding the seal material through at least one connection in the main tool opening direction.

18. The method according to claim 15, wherein the step of injecting the seal material into the second cavity includes the step of feeding the seal material through at least one connection in a direction lateral to the main tool opening direction, wherein the at least one connection is disposed in a region adjacent a dividing line, the dividing line intermediate the first main part and the second main part of the injection molding tool.

19. The method according to claim 15, wherein the plastic is a thermoplastic.

20. The method according to claim 19, wherein the thermoplastic is at least one of a glass fiber-filled polymide and a polypropylene based material.

21. The method according to claim 20, wherein the thermoplastic is PA66-GF30.

22. The method according to claim 20, wherein the thermoplastic is PP-GF30.

23. The method according to claim 15, wherein the seal material is a curing molding compound.

24. The method according to claim 15, wherein the seal material is one of ethylene propylene diene rubber, liquid silicone rubber, and fluorocarbon rubber.

25. The method according to claim 15, wherein the step of injecting the seal material into the second cavity includes the step of applying heat to the seal material.

26. The method according to claim 15, wherein the seal material is one of a one-component polyurethane molding compound and a two-component polyurethane molding compound.

27. The method according to claim 15, wherein the seal material is a thermoplastic elastomer.

28. The method according to claim 15, wherein the step of injecting the seal material into the second cavity includes the step of removing heat from the seal material.

29. The method according to claim 15, wherein the second main part has a thermometric conductivity different from a thermometric conductivity of the movable sliding element core.

30. The method according to claim 29, wherein the thermometric conductivity of the sliding element core is greater than the thermometric conductivity of the second main part.

31. A plastic box with an integrated seal configured for one of a radiator and a charge air cooler formed by the method of claim 15.
